(19) United States
(12) Patent Application Publication
(10) Pub. No.: US 2021/0258778 A1
(43) Pub. Date: Aug. 19, 2021

(54) SECURE COMMUNICATION METHOD AND DEVICE PERFORMING THE SAME

(71) Applicant: ELECTRONICS AND TELECOMMUNICATIONS RESEARCH INSTITUTE, Daejeon (KR)

(72) Inventors: Joonyoung KIM, Daejeon (KR); Sang Rok MOON, Daejeon (KR); Heuk PARK, Daejeon (KR); Minkyu SUNG, Daejeon (KR); Seung-Hyun CHO, Sejong-si (KR)

(21) Appl. No.: 17/123,588

(22) Filed: Dec. 16, 2020

(30) Foreign Application Priority Data
Dec. 20, 2019 (KR) 10-2019-0172380

(51) Int. Cl. H04W 12/033; G06N 3/04; G06N 3/08; G06N 20/20

(52) U.S. Cl. CPC H04W 12/033; G06N 20/20; G06N 3/084; G06N 3/0454

(57) ABSTRACT

A secure communication method and an apparatus performing the same are disclosed. The communication method includes receiving a signal encrypted based on at least one attractor and decrypting a security signal received using a neural network trained based on a training signal.

### CROSS-REFERENCE TO RELATED APPLICATION

This application claims the benefit of Korean Patent Application No. 10-2019-0172380 filed on Dec. 20, 2019 in the Korean Intellectual Property Office, the entire disclosure of which is incorporated herein by reference for all purposes.

### BACKGROUND

### 1. Technical Field

One or more example embodiments relate to a secure communication method and a device performing the same.

### 2. Description of Related Art

Due to the rapidly increasing number of wired and wireless devices and the emergence of various applications, sensitive personal information or confidential information is frequently transmitted. Therefore, research on physical layer security technology to reduce risks of eavesdropping in wired and wireless networks is continuously being conducted. In particular, in the case of a wireless network with an open channel environment, such information protection technology is considered essential.

In traditional physical layer security technology, confidential information is encrypted with a specific algorithm and transmitted. Since a receiver needs a security key to restore a security signal to an original message, a sender and the receiver may share the security key in advance. Such traditional technology has several limitations. First, a trusted third party or infrastructure is required for the distribution of the security key. In addition, if a quantum computer is used, a time used for decryption of the security key can be reduced compared to typical computing, so it cannot be free from the threat of eavesdropping. Thus, a system for preventing an eavesdropper from decrypting a confidential message irrespective of the computational capability of the eavesdroppers has been proposed. For this, however, there should be a security key of the same length as or longer than the confidential message to be sent.

Research on decrypting security messages without a security key has also been continuously conducted. However, it is difficult to find an efficient algorithm for interpreting an encrypted signal without using the security key. In addition, when a quantum computer with dramatically improved computing power is developed, the traditional concept of security technology may become useless.

Research on eavesdropping channel codes that ensures secured transmission regardless of the computing power of eavesdroppers without needing to share the security key is also actively being conducted. In particular, a study has been conducted to increase the security capacity by transmitting pseudo noise to lower the received signal-to-noise ratio (SNR) of the eavesdropping channel. However, when the SNR of the eavesdropping channel is lowered, the capacity of the main channel is also reduced. Accordingly, there is a desire for a physical layer security technology that may overcome these limitations.

### SUMMARY

An aspect provides a communication technology with low complexity and high security performance by transmitting a signal encrypted using a chaotic vibration of a nonlinear system and decrypting the received signal using a neural network trained in advance.

According to an aspect, there is provided a communication method including receiving a signal encrypted based on at least one attractor, and decrypting a security signal received using a neural network trained based on a training signal.

The training signal may include a message for training and a signal obtained by encrypting the message for training.

The decrypting may include classifying the security signal into a portion corresponding to each attractor included in the at least one attractor.

The at least one attractor may include a first attractor and a second attractor. The decrypting may include determining a portion corresponding to the first attractor, of the security signal to be a binary 1 and determining a portion corresponding to the second attractor, of the security signal to be a binary 0.

The communication method may further include generating the at least one attractor, encrypting a message based on the at least one attractor, and transmitting the encrypted signal.

The generating may include determining a parameter for generating an attractor and acquiring an output of a nonlinear system based on the parameter.

The nonlinear system may include a Duffing oscillator and a Lorenz system.

The encrypting may include outputting a different attractor included in the at least one attractor based on each state of the message.

The at least one attractor may include a first attractor and a second attractor.

The encrypting may include outputting the first attractor based on a binary 1 of the message and outputting the second attractor based on a binary 0 of the message.

According to another aspect, there is also provided a receiver including an antenna configured to receive a signal encrypted based on at least one attractor, and a decoder configured to decrypt a security signal received using a neural network trained based on a training signal.

The training signal may include a message for training and a signal obtained by encrypting the message for training.

The decoder may be configured to classify the security signal into a portion corresponding to each attractor included in the at least one attractor.

The at least one attractor may include a first attractor and a second attractor. The decoder may be configured to determine a portion corresponding to the first attractor, of the security signal to be a binary 1 and determine a portion corresponding to the second attractor, of the security signal to be a binary 0.

According to another aspect, there is also provided a transmitter including an encoder configured to encrypt a message based on at least one attractor, a modulator configured to modulate the encrypted signal to transmit the encrypted signal, and an antenna configured to transmit the modulated signal.

The encoder may be configured to determine a parameter for generating an attractor and acquire an output of a nonlinear system based on the parameter.

The nonlinear system may include a Duffing oscillator and a Lorenz system.

The encoder may be configured to output a different attractor included in the at least one attractor based on each state of the message.

The at least one attractor may include a first attractor and a second attractor. The encoder may be configured to output the first attractor based on a binary 1 of the message and output the second attractor based on a binary 0 of the message.

According to another aspect, there is also provided a communication system including the receiver and the transmitter.

### BRIEF DESCRIPTION OF DRAWINGS

FIG. 1 is a diagram illustrating a communication system according to an example embodiment.

FIG. 2 is a block diagram illustrating a decoder of FIG. 1.

FIG. 3 is a diagram illustrating an operation of an encoder of FIG. 1.

FIG. 4 is a diagram illustrating an operation of the decoder of FIG. 1.

FIG. 5 is a diagram illustrating an example of a signal encrypted by the encoder of FIG. 1.

FIG. 6 is a diagram illustrating an example of a signal decrypted by the decoder of FIG. 1.

FIG. 7 is a diagram illustrating an optical terahertz wired and wireless integrated communication system to which the communication system of FIG. 1 is applied.

### DETAILED DESCRIPTION OF THE INVENTION

Hereinafter, example embodiments will be described in detail with reference to the accompanying drawings. It should be understood, however, that there is no intent to limit this disclosure to the particular example embodiments disclosed. On the contrary, example embodiments are to cover all modifications, equivalents, and alternatives falling within the scope of the example embodiments.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

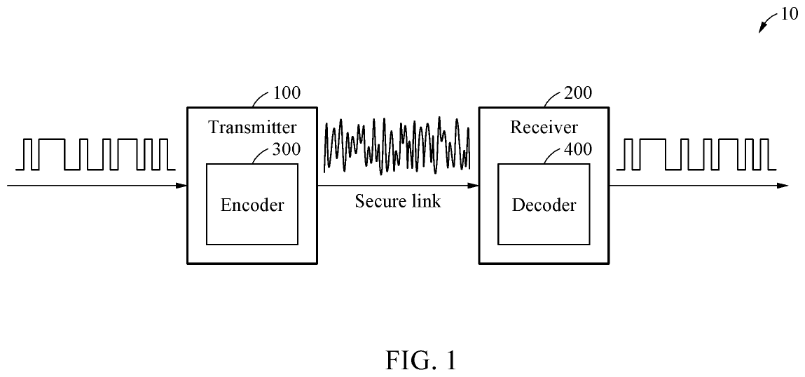

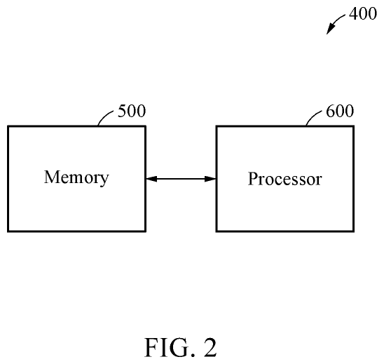

FIG. 1 is a diagram illustrating a communication system according to an example embodiment, and FIG. 2 is a block diagram illustrating a decoder of FIG. 1.

A communication system 10 may encrypt a signal using a nonlinear chaotic vibration and transmit the encrypted signal. In addition, the communication system 10 may decrypt a received signal using an artificial intelligence-based receiver trained for a chaotic vibration of a corresponding nonlinear system. Through this, the communication system 10 may provide a physical layer security communication and/or transmission link that fundamentally blocks risks of eavesdropping.

The communication system 10 may include a transmitter 100 and a receiver 200.

The transmitter 100 may transmit a security signal. For example, the transmitter 100 may generate a security signal and transmit the generated security signal to the receiver 200 through a secure link.

The transmitter 100 may include an encoder 300, a modulator (not shown), and an antenna (not shown).

The encoder 300 may encrypt or encode an input message.

The encoder 300 may encrypt a message based on an attractor. For example, the encoder 300 may encrypt a confidential message based on one or more attractors.

An attractor may be an output of a nonlinear system. The nonlinear system may include a Duffing oscillator and/or a Lorenz system.

The nonlinear system may have a plurality of parameters. When a parameter has a value in a predetermined range, the nonlinear system may output an unpredictable chaotic vibration such as noise.

An output (for example, an output of pseudo noise) of the nonlinear system seems to have no rules, but may actually draw a specific phase diagram moving along a given trajectory in an N-dimensional space. This may be referred to as an attractor of the nonlinear system.

The modulator (not shown) may modulate the encrypted signal to be transmitted. The antenna (not shown) may transmit the modulated signal.

The receiver 200 may receive the signal transmitted by the transmitter 100. For example, the receiver 200 may receive an encrypted signal.

The receiver 200 may include an antenna (not shown) and a decoder 400.

The antenna (not shown) may receive the signal transmitted by the transmitter 100.

The decoder 400 may decrypt or decode the encrypted signal. The decoder 400 may include a memory 500 and a processor 600.

The processor 600 may process the signal received by the receiver 200 and/or data stored in the memory 500. The processor 600 may execute a computer-readable code (e.g., software) stored in the memory 500 and instructions induced by the processor 600.

The processor 600 may be a data processing device implemented in hardware with a circuit having a physical structure for executing desired operations. For example, the desired operations may include a code or instructions included in a program.

For example, the data processing device implemented in hardware may include a microprocessor, a central processing unit, a processor core, a multi-core processor, a multiprocessor, an application-specific integrated circuit (ASIC), and a field programmable gate array (FPGA).

The processor 600 may decrypt a signal encrypted based on at least one attractor. The processor 600 may decrypt a security signal encrypted using a neural network trained based on a training signal.

The neural network may include a deep neural network. The neural network may include a convolutional neural network (CNN), a recurrent neural network (RNN), a perceptron, a feed forward (FF), a radial basis network (RBF), a deep feed forward (DFF), a long short term memory (LSTM), a gated recurrent unit (GRU), an autoencoder (AE), a variational autoencoder (VAE), a denoising autoencoder (DAE), a sparse autoencoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

The training signal may include a confidential message for training and a security signal for training obtained by encrypting the corresponding message. For example, the training signal may include a signal obtained by encrypting a confidential message for training based on an attractor and also include a training signal in which a noise signal is mixed.

The neural network may include an input layer, a plurality of hidden layers, and an output layer. In terms of a node of a hidden layer, a parameter may be set according to learning performed based on a training signal before the processor 600 initiates decryption.

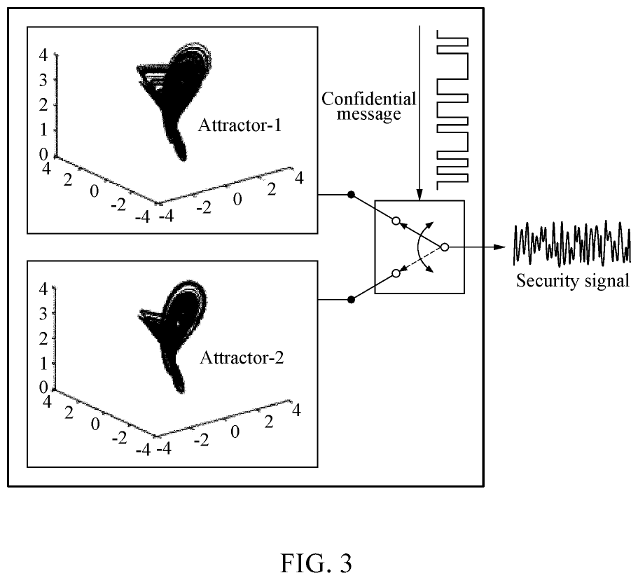

FIG. 3 is a diagram illustrating an operation of the encoder of FIG. 1.

The encoder 300 may encrypt a message based on an attractor.

The encoder 300 may generate at least one attractor. For example, the encoder 300 may generate attractors using different parameters. The encoder 300 may acquire an output (for example, a chaotic vibration) of a nonlinear system based on different parameters.

The encoder 300 may calculate an output of a Lorenz system based on two different parameters. Although FIG. 3 shows the Lorenz system as an example, it is merely an example, and all nonlinear systems that generate the chaotic vibration can be used.

For example, the encoder 300 may generate a first attractor (Attractor-1) and a second attractor (Attractor-1) by substituting a first parameter (σ1, ρ1, β1) and a second parameter (σ2, ρ2, β2) to each of Equations 1 through 3.

\dot{x}=σ(y−x) [Equation 1]

\dot{y}=ρx−y−20xz [Equation 2]

ż=5xy−βz [Equation 3]

The encoder 300 may encrypt a message based on the first attractor and the second attractor. For example, the encoder 300 may encrypt a confidential message based on the first attractor and the second attractor and output security signal.

Although FIG. 3 shows that a message includes two states of 0 and 1, it is merely an example and the message may also include three or more states. The encoder 300 may generate the same number of attractors as the number of states included in the message.

For example, the message may be represented by 0, ½, and 1. In this example, the encoder 300 may generate the first attractor through a third attractor to encrypt the message.

For ease and convenience, the following description is based on a case in which the message is expressed by a binary 0 and a binary 1.

The encoder 300 may output a security signal by generating the security signal such that the first attractor corresponds to the binary 1 of the message and the second attractor corresponds to the binary 0 of the message. In other words, the encoder 300 may output the first attractor corresponding to the binary 1 of the message and output the second attractor corresponding to the binary 0.

Unlike the example described above, the encoder 300 may match the binary 1 and the binary 0 to the second attractor and the first attractor, respectively.

Accordingly, the encoder 300 may generate a security signal that includes information of the message but randomly shows the first attractor and the second attractor mixed therein.

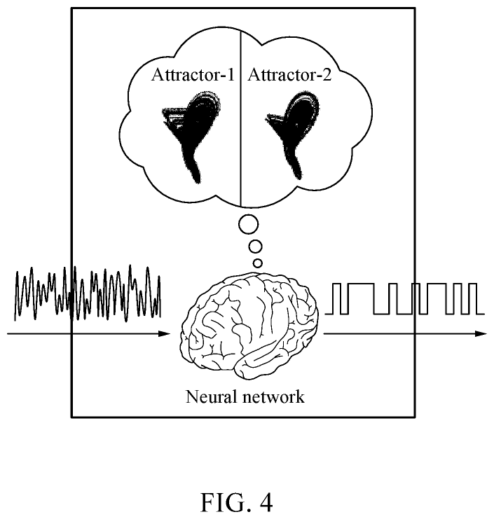

FIG. 4 is a diagram illustrating an operation of the decoder of FIG. 1.

The decoder 400 may decrypt a signal encrypted based on at least one attractor. For example, the decoder 400 may decrypt a signal encrypted using a trained neural network.

To interpret an attractor (or chaotic vibration), an analytical method has been used in the past. However, since the analytical method accompanies excessively complicated formulas and requires a specific initial condition, it is difficult to apply the analytical method to various communication fields including security.

The decoder 400 may use a neural network that has learned a confidential message for training and a security signal for training obtained by encrypting the corresponding message. In a hidden layer of the neural network, a parameter may be set according to the learning performed before the decoder 400 is operated.

The neural network may decrypt a security signal encrypted based on the first attractor and the second attractor. For example, the neural network may recover a message included in the security signal by classifying a portion corresponding to the first attractor and a portion corresponding to the second attractor, of the security signal.

For example, the neural network may determine a portion corresponding to the first attractor, of the security signal to be a binary 1 and determine a portion corresponding to the second attractor, of the security signal to be a binary 0. In this instance, unlike the example described above, the neural network may match the first attractor and the second attractor to the binary 0 and the binary 1, respectively.

Accordingly, by using the neural network, the decoder 400 may recover the signal encrypted based on the first attractor and the second attractor to a signal constructed by the binary 0 and the binary 1.

Although FIG. 4 illustrates the message including two states of 0 and 1 for ease of description, it is merely an example, and the message may include three or more states in some cases. In such cases, the decoder 400 may decrypt a message encrypted based on three or more attractors.

For example, the decoder 400 may classify a message encrypted based on the first attractor through an n-th attractor into portions corresponding to the first attractor through the n-th attractor.

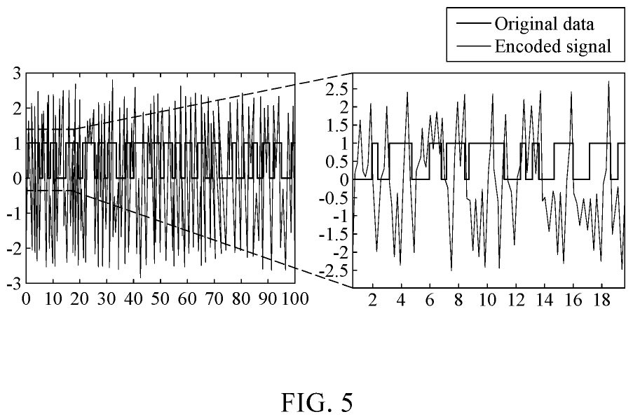

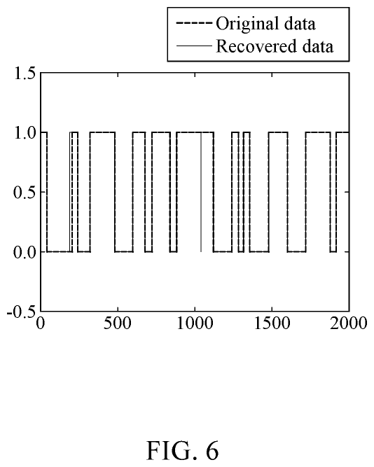

FIG. 5 is a diagram illustrating an example of a signal encrypted by the encoder of FIG. 1, and FIG. 6 is a diagram illustrating an example of a signal decrypted by the decoder of FIG. 1.

FIG. 5 illustrates a simulation result of a process of encrypting a security signal by the encoder 300. To encrypt an original message in the simulation, a Lorenz system is calculated using a fourth degree Runge-Kutta method.

An encoded signal of FIG. 5 refers to an encrypted security signal. It is confirmed that any clue of original data cannot be found in the encrypted security signal.

FIG. 6 shows a result of simulation in which the decoder 400 decrypts a security signal using a neural network trained using an attractor of the Lorenz system. Original data of FIG. 6 refers to an original message. Recovered data refers to a message decrypted by the decoder 400. It can be confirmed that the original message matches the decrypted message.

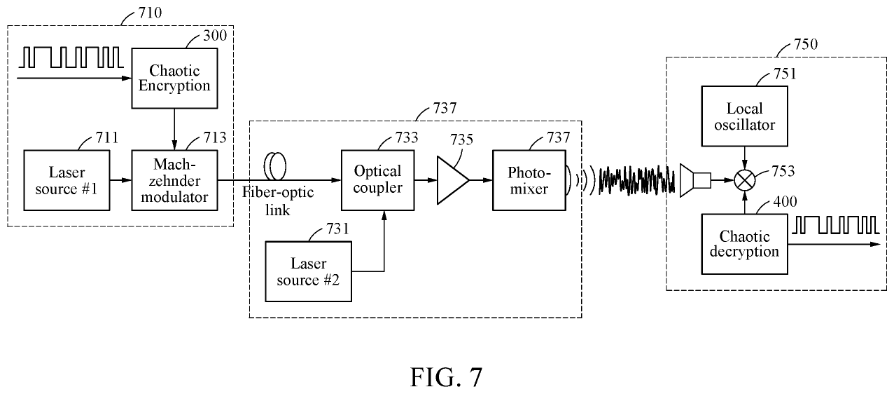

FIG. 7 is a diagram illustrating an optical terahertz wired and wireless integrated communication system to which the communication system of FIG. 1 is applied.

An optical terahertz wired and wireless integrated communication system 20 may be an optical terahertz wired and wireless integrated network that employs the communication system 10 and has strengthened security. The optical terahertz wired and wireless integrated communication system 20 may include a transmitter 710, an optical receiver 730, and a wireless receiver 750.

The transmitter 710 may encrypt a message and transmit the encrypted message to the optical receiver 730 through an optical link. The transmitter 710 may include the encoder 300, a laser light source 711, and a modulator 713.

The laser light source 711 may be a tunable laser diode. The laser light source may output light of a predetermined frequency.

The modulator 713 may modulate the signal encrypted by the encoder 300 (for example, a signal encrypted based on an attractor) based on the light of the predetermined frequency.

The signal modulated by the modulator 713 may pass through an optical path and input to the optical receiver 730.

The optical receiver 730 may up-convert the signal input through optical beating into a radio frequency band (for example, fTHz) and then transmit the signal through a radio link. The optical receiver 730 may include a laser light source 731, an optical coupler 733, an optical amplifier 735, and a photomixer 737.

The laser light source 731 may be a tunable laser diode. The laser light source 731 may output light having a difference corresponding to a predetermined frequency (for example, fTHz) when compared to the laser light source 711.

The optical coupler 733 may couple the signal input through the optical path and the light output from the laser light source 731. The optical amplifier 735 may amplify the light coupled by the optical coupler 733.

The photomixer 737 may emit the signal amplified by the optical amplifier 735 to a free space through an antenna.

The wireless receiver 750 may receive a signal transmitted by the optical receiver 730. The wireless receiver 750 may decrypt the received signal by converting a frequency of the signal into a base band.

The wireless receiver 750 may include a local oscillator 751, a mixer 753, and the decoder 400.

The local oscillator 751 and the mixer 753 may convert the frequency of the received signal into the base band.

The decoder 400 may decrypt a signal encrypted based on an attractor using a neural network, thereby recovering an original message.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A communication method comprising:
receiving a signal encrypted based on at least one attractor; and
decrypting a security signal received using a neural network trained based on a training signal.

2. The communication method of claim 1, wherein the training signal comprises a message for training and a signal obtained by encrypting the message for training.

3. The communication method of claim 1, wherein the decrypting comprises classifying the security signal into a portion corresponding to each attractor included in the at least one attractor.

4. The communication method of claim 1, wherein the at least one attractor comprises a first attractor and a second attractor, and
the decrypting comprises:
determining a portion corresponding to the first attractor, of the security signal to be a binary 1 and determining a portion corresponding to the second attractor, of the security signal to be a binary 0.

5. The communication method of claim 1, further comprising:
generating the at least one attractor;
encrypting a message based on the at least one attractor; and
transmitting the encrypted signal.

6. The communication method of claim 5, wherein the generating comprises:
determining a parameter for generating an attractor; and
acquiring an output of a nonlinear system based on the parameter.

7. The communication method of claim 6, wherein the nonlinear system comprises a Duffing oscillator and a Lorenz system.

8. The communication method of claim 5, wherein the encrypting comprises:
outputting a different attractor included in the at least one attractor based on each state of the message.

9. The communication method of claim 5, wherein the at least one attractor comprises a first attractor and a second attractor, and
the encrypting comprises:
outputting the first attractor based on a binary 1 of the message and outputting the second attractor based on a binary 0 of the message.

10. A receiver comprising:
an antenna configured to receive a signal encrypted based on at least one attractor; and
a decoder configured to decrypt a security signal received using a neural network trained based on a training signal.

11. The receiver of claim 10, wherein the training signal comprises a message for training and a signal obtained by encrypting the message for training.

12. The receiver of claim 10, wherein the decoder is configured to classify the security signal into a portion corresponding to each attractor included in the at least one attractor.

13. The receiver of claim 10, wherein the at least one attractor comprises a first attractor and a second attractor, and
the decoder is configured to determine a portion corresponding to the first attractor, of the security signal to be a binary 1 and determine a portion corresponding to the second attractor, of the security signal to be a binary 0.

14. A transmitter comprising:
an encoder configured to encrypt a message based on at least one attractor;
a modulator configured to modulate the encrypted signal to transmit the encrypted signal; and
an antenna configured to transmit the modulated signal.

15. The transmitter of claim 14, wherein the encoder is configured to determine a parameter for generating an attractor and acquire an output of a nonlinear system based on the parameter.

16. The transmitter of claim 15, wherein the nonlinear system comprises a Duffing oscillator and a Lorenz system.

17. The transmitter of claim 14, wherein the encoder is configured to output a different attractor included in the at least one attractor based on each state of the message.

18. The transmitter of claim 14, wherein the at least one attractor comprises a first attractor and a second attractor, and
the encoder is configured to output the first attractor based on a binary 1 of the message and output the second attractor based on a binary 0 of the message.

19. (canceled)
